(19) United States
(12) Patent Application Publication
(10) Pub. No.: US 2020/0394674 A1
(43) Pub. Date: Dec. 17, 2020

(54) METHOD FOR THE MANAGEMENT OF LOYALTY IDENTIFIERS, METHOD FOR THE PROCESSING OF LOYALTY DATA, CORRESPONDING SERVER, TRANSACTION DEVICE AND PROGRAMS

(71) Applicant: INGENICO GROUP, Paris (FR)

(72) Inventor: Pierre Quentin, Enghien Les Bains (FR)

(21) Appl. No.: 16/622,028

(22) PCT Filed: Jun. 13, 2018
(86) PCT No.: PCT/EP2018/065575

§ 371 Date: Dec. 12, 2019

(30) Foreign Application Priority Data
Jun. 13, 2017 (FR) 1755283

(51) Int. Cl. G06Q 30/02; G06F 16/9535

(52) U.S. Cl. CPC G06Q 30/0226; G06K 7/10297; G06F 16/9535; G06Q 30/0236

(57) ABSTRACT

A method of management of loyalty identifiers. The method is implemented in a loyalty identifiers management server and includes a phase of initialization having an act of generating a general loyalty identifier for a preliminarily identified user, the general loyalty identifier being associated with a plurality of specific loyalty programs of the user. The proposed technique also relates to a method for processing loyalty data by a merchant's transaction device.

### 1. FIELD OF THE INVENTION

The present invention relates to the field of payment operations and more particularly to the optimized management of customer loyalty data.

### 2. PRIOR ART

From time immemorial, creating customer loyalty has been by which a merchant can ensure a regular income and hence develop and sustain his activity. However, for many years now, it has been seen that there are two major types of coexisting technologies used to ensure a certain loyalty from a set of customers.

The first most basic type of loyalty creation lies in the printing of a physical loyalty card, for example in the form of a “paper” or “plastic” loyalty card that may or may not be stampable or have a bar code to be scanned.

The stampable loyalty card makes it possible, when the customer goes through a cashier's till, to obtain one or more stamps on his card depending for example on the amount of his purchase. Such a loyalty card can be coupled with the transmission to the customers, generally by postal mail, of reduction coupons or loyalty coupons.

A bar code loyalty card, for its part, can be used to obtain the benefit of an immediate reduction on a purchase that the user is purchasing, or again to accumulate loyalty points associated with a purchase operation in order to subsequently obtain an advantage that rewards him for his loyalty. This bar code loyalty card can also be coupled with a transmission of reduction coupons or loyalty coupons to the customers, generally by email and/or by SMS.

These “physical” identity cards must therefore be presented to the merchant by the user, whether it is to be stamped or to be scanned if he wishes to obtain the advantages of the loyalty program that he has subscribed to or joined. In addition, this type of “physical” loyalty card also often requires that the user should furnish the merchant with additional information to identify himself in a loyalty program, for example his particulars (name and address), his email address and/or his mobile phone number.

The second type of implementation of customer loyalty creation consists of the use of existing technological communications solutions. This second type relies for example on a “virtual” loyalty card associated with the specific number (for example a specific identifier corresponding to a membership number), this specific number being used extensively with the customer's particulars (address, email, telephone number, social networks) to propose to him, via various communications channels, not only a management of a specific loyalty program but also a transmission of sales offers and reduction coupons. For example, the transmission of this information can be done by electronic mail, by SMS or again by “in-app” type messages (apps using a technology in which notifications are transmitted to an application installed on a smartphone when the user uses the application in question). More recently, the integration of the loyalty management into smartphones has been improved through the use of wallets.

However, even with this second type of “virtual” loyalty card, the user must open an application in his smartphone dedicated to loyalty management for the selection and display therein of the loyalty card corresponding to the merchant with whom he is making a transaction, either so that the merchant will scan the associated bar code (somewhat as in the case of “physical” loyalty card) or so that the merchant will enter the membership number into his customer loyalty management system.

There is therefore a need to provide users with a loyalty solution that is optimal in terms of ergonomy while at the same time being both simple and low cost for the merchant.

### 3. SUMMARY OF THE INVENTION

The proposed technique does not have these drawbacks of the prior art. More particularly, according to one aspect, the proposed technique relates to a method for the management of loyalty identifiers. This method is implemented in a loyalty identifiers management server and comprises a phase of initialization comprising a step for generating a general loyalty identifier for a preliminarily identified user.

Thus, according to this first aspect of the proposed technique, the method for the management of loyalty identifiers enables the association, in a preliminary phase of initialization, of a general loyalty identifier with a preliminarily identified user so as to simplify the management of the different specific loyalty programs of which the user in question is a member.

To this end, the loyalty identifiers management server therefore creates, for example in a database, a general loyalty identifier in order to carry out centralized management of all the loyalty data associated with this user, whichever the merchants concerned.

This preliminary phase of initialization is implemented preferably outside the time of a purchase made by the user, so that the user's general loyalty identifier is available at the time of these subsequent purchases.

According to one particular aspect, the phase of initialization also comprises the following steps respectively before and after the step of generation:
Receiving a request, from the user's communications terminal, for generation of a general loyalty identifier associated with the user, the request for generation comprising at least one piece of data for identifying the user;
transmission, to the user's communications terminal, of a response comprising the general loyalty identifier generated.

According to one particular embodiment, the initialization phase is implemented following the reception of a request sent out by a communications terminal of the user (for example a smartphone or a tablet or again a computer).

This request can for example be issued by a loyalty application pre-installed on the user's communications terminal through which the user can manage his different loyalty programs. In the initialization phase, the request comprises at least one piece of data to identify the user such that that the loyalty identifiers management server can generate a unique general identifier for the user in question. Such a piece of data for identification of the user corresponds for example to his family name and/or his first name and/or to a pseudonym and/or a unique number generated by the application itself.

In addition, once the general loyalty generator has been generated, the loyalty identifiers management server sends it, in response to the request, to the communications terminal of the user. Should a dedicated loyalty application have issued the request, this application receives the general loyalty identifier associated with the user and uses it so as to simplify the management of the user's loyalty locally on his communications terminal.

According to one particular embodiment, the method furthermore comprises the following steps:
receiving, from the user's communications terminal or from a merchant's transaction device, a request for updating the user's general loyalty identifier, the update request comprising the user's general loyalty identifier and at least one specific loyalty identifier of the user for the merchant;
updating the general loyalty identifier by association between the at least one specific loyalty identifier of the user for the merchant and the user's general loyalty identifier.

According to this embodiment, the proposed method enables the association of a plurality of specific loyalty identifiers of the user, for a plurality of merchants, with his general loyalty identifier.

The user's general loyalty identifier can therefore be updated, for example via the loyalty application installed in the user's communications terminal, to add a loyalty card specific to a merchant.

To this end, the loyalty identifiers management server receives an update request comprising, at the same time, the user's general loyalty identifier (generated during the preliminary initialization phase) and a specific loyalty identifier of the user for the given merchant, such as for example a membership number. The server can then associate the specific loyalty identifier with the user's general loyalty identifier. In this way, the user of the general loyalty identifier enables the management of the user's loyalty program for the merchant concerned.

Here again, these steps for updating the user's general loyalty identifier are implemented preferably outside the time of the purchase made by the user.

However, these steps can also be implemented at the time of a purchase from a merchant, via the transaction device used for this purchase. This “smart” update thus enables a user to enjoy the loyalty benefits for a purchase in progress even if he is not a member in a merchant's loyalty program before his purchase. This implementation further facilitates the management of loyalty for the user.

According to one particular characteristic, the method furthermore comprises a step of transmission, to the user's communications terminal, of a piece of information representing the updated general loyalty identifier.

Thus, according to this embodiment, when the loyalty application installed in the user's communications terminal has sent out a request for updating the user's general loyalty identifier, it receives a response to its request from the loyalty identifiers management server.

In addition, when the request has been sent out by a transaction device of a merchant (for example at the time of a purchase) and not by the loyalty application itself, this application nevertheless receives a piece of information enabling it to know of the update made. In this way, the user can always have available a current status of his general loyalty identifier and therefore his specific loyalty programs, through his application installed on his communications terminal.

According to one particular embodiment, the method furthermore comprises the following steps:
reception, from a transaction device associated with a merchant, of a request for obtaining a specific loyalty identifier of the user for the merchant, the request for obtaining comprising the user's general loyalty identifier;
obtaining at least one piece of identification data for the merchant;
searching, on the basis of the merchant's identification data and the user's general loyalty identifier, for the user's specific loyalty identifier for the merchant:
   when the search is positive, transmission to the transaction device of a response comprising the user's specific loyalty identifier for the merchant;
   when the search is negative, transmission to the transaction device of a negative response.

According to this embodiment, the proposed method therefore enables a transaction device (an electronic payment terminal, a cash register, etc.) to retrieve, from the loyalty identifiers management server, a specific loyalty identifier for a merchant on the basis of the user's general loyalty identifier. In this way, when the user wishes to obtain the benefits of a loyalty program corresponding to a purchase made with a merchant, he can provide only his general loyalty identifier without having to search for his specific loyalty identifier. This greatly simplifies the management of his loyalty, especially when this general loyalty identifier can be provided to the transaction device “automatically” for example via the payment means used by the user to make his purchase via his communications terminal as described in greater detail here below.

To this end, the transaction device therefore transmits a request to the loyalty identifiers management server in order to obtain the specific loyalty identifier associated with the user for the given merchant. This request must contain at least the user's general loyalty identifier, obtained in different ways described here below.

Upon reception of this request, the loyalty identifiers management server obtains an identification of the merchant, for example via a piece of data also present in the request (a public key of the transaction device, an identifier of the merchant or of the transaction device) or via a piece of information for locating the transaction device enabling it to find the associated merchant.

Using these two pieces of information (general loyalty identifier of the user and merchant's identification), the loyalty identifiers management server can make a search to see whether the user's general loyalty identifier is associated with a specific loyalty identifier of the user for this merchant.

If this is the case, the server, in response to this request, sends this specific loyalty identifier.

If not, the server sends a negative response, indicating that the user's general loyalty identifier does not enable the management of the user's specific loyalty to this merchant.

These steps of use of the user's general loyalty identifier are for example implemented at the time of a purchase made by the user, conventionally at the start or at the end of the transaction (as in the case when the user presents a “physical” loyalty card to be stamped or scanned).

According to another aspect, the proposed technique relates to a method for processing loyalty data. This method is implemented in a transaction device of a merchant and comprises the following steps:
obtaining, from a user, a general loyalty identifier of the user;
sending, to a loyalty identifiers management server, a request for obtaining a specific loyalty identifier of the user for the merchant, the request for obtaining comprising at least the user's general loyalty identifier;
reception, from the loyalty identifiers management server, of a response to the request for obtaining and, if the response comprises a specific loyalty identifier of the user for the merchant:
processing at least one piece of loyalty data associated with a specific loyalty identifier of the user for the merchant.

Thus, according to this second aspect of the proposed technique, implemented in a transaction device (an electronic payment terminal, a cash register, etc.), at the time of a purchase made by the user, the loyalty data processing method enables this transaction device to retrieve, from the loyalty identifiers management server, a specific loyalty identifier for the merchant associated with the transaction data, on the basis of the user's general loyalty identifier, so as to be able to manage the user's loyalty data specific to the merchant in question.

To this end, the transaction device obtains the user's general loyalty identifier, for example through the payment means used by the user (his payment card, his smartphone, etc.) and sends a request to the loyalty identifiers management server to retrieve the user's specific loyalty identifier for the given merchant.

If the user is truly affiliated with the merchant's loyalty program, and if he has updated his general loyalty identifier with his specific loyalty identifier, then the loyalty identifiers management server, in response to the request from the transaction device, forwards this specific loyalty identifier. The transaction device can then use this specific loyalty identifier to manage the user's specific loyalty program, with reference to the purchase made.

According to one particular aspect, the method comprises the following steps, if the response is negative:
obtaining a specific loyalty identifier of the user for the merchant;
sending, to the loyalty identifiers management server, a request for updating the user's loyalty identifier, the update request comprising the user's general loyalty identifier and the user's specific loyalty identifier for the merchant;
processing at least one piece of loyalty data associated with the user's specific loyalty identifier for the merchant.

Thus, according to this embodiment, if the user is affiliated or is not a member of the merchant's loyalty program, or if he has not previously updated his general loyalty identifier with his specific loyalty identifier, then the loyalty identifiers management server cannot find the specific loyalty identifier required, and transmits a negative response to the transaction device.

In this case, the transaction device is capable of requesting an update of the user's general loyalty identifier so that the specific loyalty program for the merchant in question is taken into account. This update can be done after permission from the user, either at the very time of the update request or preliminarily by a “general” authorization given by the user (for example via the loyalty program installed on his communications terminal).

To carry out this update, the transaction device sends out a request to the loyalty identifiers management server with the user's general loyalty identifier and the user's specific loyalty identifier for the merchant in question. This specific identifier, if it already exists, can be given to the transaction device by the user (for example via his payment means) or else it can be created and provided by a specific loyalty server of the merchant at the time of the process.

In parallel with this update request, the transaction device uses the user's specific loyalty identifier to manage his specific loyalty program in relation to the purchase made.

For example, the step for obtaining a specific loyalty identifier for the merchant and the step for processing are updated via a specific loyalty program management server associated with the merchant.

Thus, according to this embodiment, the transaction device does not manage the merchant's loyalty programs internally and therefore communicates with a specific loyalty server of the merchant to manage the user's specific loyalty program and also; if it does not exist as yet, to obtain the user's specific loyalty identifier for the merchant in question.

According to one particular characteristic, the step of obtaining a general loyalty identifier of the user is implemented via communications means with a communications terminal of the user belonging to the sub-group comprising:
NFC;
Bluetooth;
MST (Magnetic Secure Transmission).

Thus, according to this embodiment, the transaction device can obtain the user's general loyalty identifier by different means.

For example, the user can display his identifier which can be scanned on his smartphone (via the loyalty application). The identifier can also be transmitted via very short distance wireless communications means (Bluetooth) or contactless means (of the NFC type) between the user's smartphone and the transaction device. According to yet another variant, the identifier can be provided by a technique for mimicking the magnetic field generated by a magnetic stripe card, for example via the transmission of secondary data. According to another variant, the general loyalty identifier can take the form of a QR code, displayed for example on the user's smartphone and read by the transaction device. According to yet another variant, the general loyalty identifier can be entered manually, by the user or by the merchant, on the transaction device.

According to a preferred implementation, the different steps of the methods described here above, according to the proposed technique, are implemented by several software programs or computer programs, comprising software instructions intended for execution by a data processor of a relay component according to the proposed technique and being designed to command the execution of the different steps of the methods.

The proposed technique is therefore also aimed at providing a program liable to be executed by a computer or by a data processor, this program comprising instructions to command the execution of the steps of a method as mentioned here above.

This program can use any programming language whatsoever and can be in the form of source code, object code or intermediate code between source code and object code such as in a partially compiled form or in any other desirable form whatsoever

The proposed technique is also aimed at providing an information medium readable by a data processor, and comprising instructions of a program as mentioned here above.

The information medium can be any entity or communications terminal whatsoever capable of storing the program. For example, the medium can comprise a storage means such as a ROM, for example, a CD ROM or microelectronic circuit ROM or again a magnetic recording means, for example a floppy disk or a hard disk drive.

Besides, the information media can be a transmissible medium such as an electrical or optical signal, that can be conveyed via an electrical or optical cable, by radio or by other means. The programs according to the proposed technique can especially be downloaded from an Internet type network.

As an alternative, the information medium can be an integrated circuit into which the program is incorporated, the circuit being adapted to executing or to being used in the execution of the method in question.

According to one embodiment, the proposed technique is implemented by means of software and/or hardware components. In this respect, the term “component” can correspond, in this document, equally well to a software component and to a hardware component or to a set of hardware and software components.

A software component corresponds to one or more computer programs, one or more sub-programs of a program or more generally to any element of a program or a piece of software capable of implementing a function or a set of functions as described here below for the module concerned. Such a software component is executed by a data processor of a physical entity (terminal, server, gateway, router, etc.) and is liable to access the hardware resources of this physical entity (memories, recording media, communications buses, electronic input/output boards, user interfaces, etc.).

In the same way, a hardware component corresponds to any element of a hardware unit capable of implementing a function or a set of functions, according to the description below for the module concerned. It can be a programmable hardware component or a component with an integrated processor for the execution of software, for example an integrated circuit, a smartcard, a memory card, an electronic board for the execution of firmware, etc.

Each component of the system described here above naturally implements its own software components.

The proposed technique also relates a loyalty identifiers management server comprising means for generating a general loyalty identifier for a preliminarily identified user for the implementing of the method for managing loyalty identifiers as described here above.

According to another aspect, the proposed technique also relates to a transaction device comprising the following means to implement the steps of the loyalty data processing method, as described here above:
means for obtaining, from a user, a general loyalty identifier of the user;
means for sending, to a loyalty identifiers management server, a request for obtaining a specific loyalty identifier of the user for the merchant, the request for obtaining comprising at least the user's general loyalty identifier;
means of reception, from the loyalty identifiers management server, of a response to the request for obtaining and, if the response comprises the user's specific loyalty identifier for the merchant:
means for processing at least one piece of loyalty data associated with the user's specific loyalty identifier for the merchant.

The different embodiments mentioned here above can be combined with one another to implement the proposed technique.

### 4. FIGURES

Other features and advantages of the invention shall appear more clearly from the following description of a preferred embodiment, given by way of a simple, illustratory and non-exhaustive example and from the appended drawings, of which:

FIG. 1 illustrates the main steps of the method for the management of loyalty identifiers, according to one particular embodiment;

FIGS. 2 and 3 present two sequence diagrams presenting the main steps of a method for the management of loyalty identifiers and a method for the processing of loyalty data, according to two particular embodiments;

FIG. 4 describes a simplified architecture of a loyalty identifiers management server capable of implementing a method of management of loyalty identifiers according to one particular embodiment;

FIG. 5 describes a simplified architecture of a transaction device capable of implementing a loyalty data processing method according to one particular embodiment.

### 5. DESCRIPTION

### 5.1. General Principle

The general principle of the proposed technique consists of the association, for a given user of a unique general loyalty identifier with loyalty programs of different merchants. This association, as well as the subsequent update of the general loyalty identifier, is implemented by a loyalty identifiers management server.

The proposed technique therefore enables the implementation of a centralized system of management of a plurality of specific loyalty programs for a user, via a general loyalty identifier.

Thus, whenever a user wishes to obtain loyalty benefits related to a specific loyalty program of which he has become a member, he provides this general loyalty identifier instead of providing the appropriate specific loyalty identifier.

From a user's viewpoint, the management of loyalty is therefore greatly simplified because the proposed technique optimizes the use of virtual loyalty cards as described with reference to the prior art in grouping them transparently “behind” a general loyalty identifier. For example, a dedicated loyalty application installed in a communications terminal of the user can enable him to have, at his disposal, his general loyalty identifier which he can then provide, when he has need of it, whichever the merchant concerned.

According to a first aspect of the proposed technique, the management of a general loyalty identifier for a user is therefore implemented by a loyalty identifiers management server that is capable of translating this general loyalty identifier of the user into a preliminarily associated specific loyalty identifier that is then usable by a merchant's transaction device for a specific management of loyalty related to this merchant.

According to a second aspect of the proposed technique, a merchant's transaction device is capable of communicating with the loyalty identifiers management server to transmit the general loyalty identifier provided by a user to it and, in return, to receive the user's specific loyalty identifier for the merchant in question in order to then manage the user's specific loyalty program for this merchant.

Finally, for a third aspect of the proposed technique, a dedicated loyalty application installed in a communications terminal of a user (for example a smartphone, a tablet or a computer) can provide him with an interface enabling him to manage his different loyalty programs in a centralized way, configure his loyalty profile, etc. According to this third aspect, this dedicated application is also capable of communicating with the loyalty identifiers management server, on the one hand to request the creation/generation of the general loyalty identifier for the user and, on the other hand, to update this general loyalty identifier of the user with the user's different specific loyalty programs, via specific loyalty identifiers.

These three aspects of the proposed technique are described in detail here below.

### 5.2. Method for the Management of Loyalty Identifiers

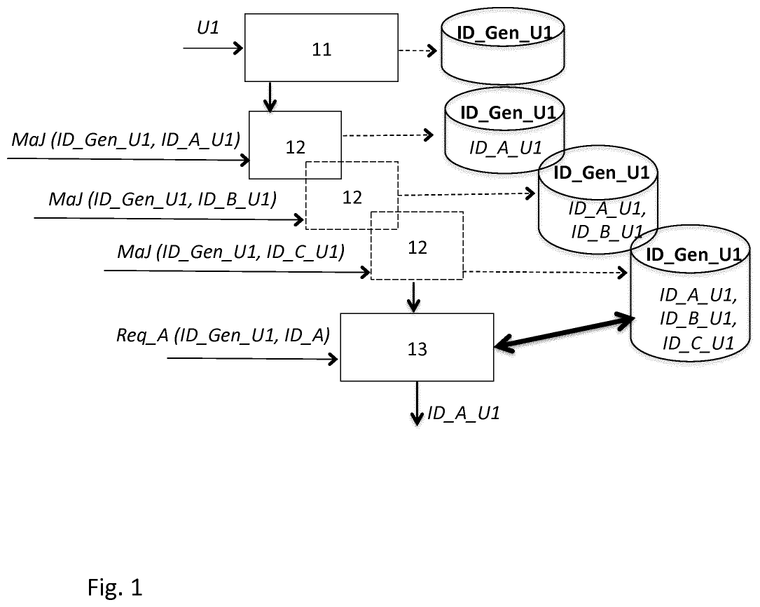

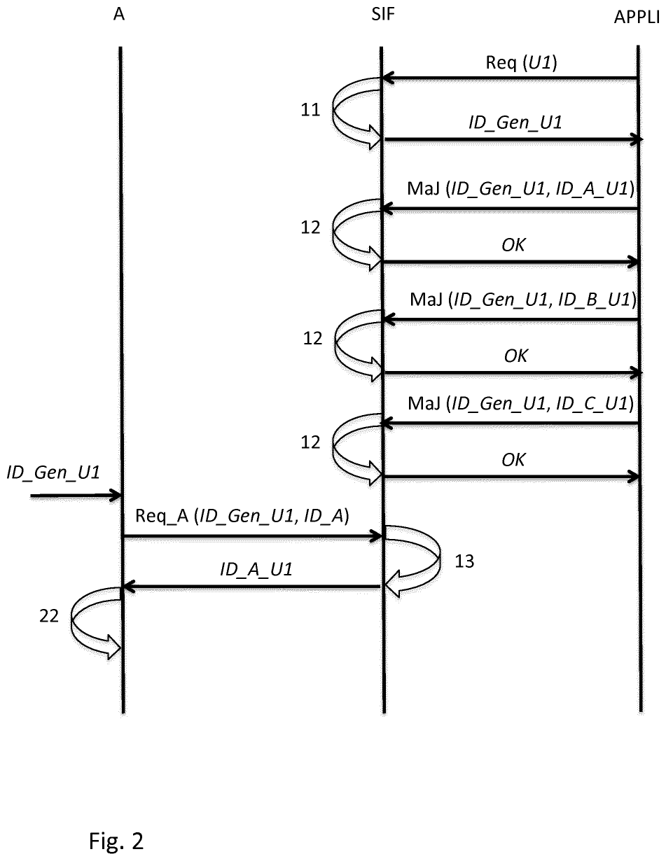

According to a first aspect, the proposed technique therefore relates to a method for the management of loyalty identifiers, implemented in a loyalty identifiers management server, the general steps of which are illustrated in FIGS. 1 and 2, in one particular embodiment.

This method for the management of loyalty identifiers comprises first of all an initialization phase, during which the general loyalty identifier of a user U1 is created/generated. Thus, at a generation step 11, the loyalty identifiers management server generates (for example in a database that can be manipulated/managed by means of a software library, or in a flat file (text or XML)), a general loyalty identifier ID_Gen_U1, associated with a preliminarily identified user U1.

This initialization phase can be triggered upon the user's request, via his communications terminal, as illustrated in FIG. 2.

According to this embodiment, the loyalty identifiers management server SIF receives a request Req (U1) for the generation of a general loyalty identifier, coming from a communications terminal of the user U1, the request comprising at least one piece of information enabling the identification of the user U1 (for example a family name, first name, pseudonym, etc.). For example, this request is sent out via a dedicated application APPLI installed in the user's communications terminal, making it possible to offer the user an interface for the management of his loyalty data.

The general loyalty identifier is then updated, during one or more successive updating steps 12, to associate with it one or more specific loyalty identifiers of the user: ID_A_U1 for the merchant A, ID_B_U1 for the merchant B, ID_C_U1 for the merchant C, etc. In this way, these specific loyalty identifiers are accessible from a unique “entry point” constituted by the general loyalty identifier which can be augmented with other specific loyalty identifiers as and when these updates are made.

These updating steps can also be triggered upon a request by the user through his communications terminal at the same time as the step for generating a general loyalty identifier or subsequently as illustrated in FIG. 2.

Thus, according to this embodiment, the loyalty identifiers management server SIF receives one or more update requests MAJ (ID_Gen_U1, ID_A_U1), MAJ (ID_Gen_U1, ID_B_U1), MAJ (ID_Gen_U1, ID_C_U1), etc. for updating the general loyalty identifier ID_Gen_U1, coming from the communications terminal of the user U1 (for example via the application APPLI). Each request comprises at least the user's general loyalty identifier ID_Gen_U1 and the specific loyalty identifier of the merchant to be associated ID_A_U1, ID_B_U1, ID_C_U1, etc.

FIG. 2 illustrates three steps of successive updating, carried out successfully by the loyalty identifiers management server SIF, which sends back for example an “OK” to the application that has originated the request.

By contrast, if the loyalty identifiers management server SIF has not been able to implement the required update, whether it is because the specific identifier is already associated with the general identifier or because the general identifier does not yet exist, a response indicating failure can be sent by the loyalty identifiers management server to the application that has originated the request (this case is not illustrated).

As already described here above, a user's general loyalty identifier can enable him to carry out a simplified management of his loyalty, whatever the loyalty program concerned, hence whichever the merchant concerned. This simplified management consists in using this general loyalty identifier in all situations where the user must provide a piece of data enabling him to be identified as having become a member of a merchant's specific loyalty program.

For example, if the user wishes, during a purchase, to enjoy all the advantages of the loyalty program of which he has become a member, with a given merchant, all he has to do, according to the different methods described in detail here below, is to provide his general loyalty identifier ID_Gen_U1 to the transaction device implementing this purchase. Since the transaction device needs a user's specific loyalty identifier (for the merchant in question) to manage a specific loyalty program, this transaction device must obtain this specific loyalty identifier using the general loyalty identifier given by the user.

To this end, and as illustrated in FIG. 2, the transaction device implementing the purchase transmits the general loyalty identifier provided by the user, in a request Req_A (ID_Gen_U1, ID_A), to the loyalty identifiers management server in order to obtain in return the user's specific loyalty identifier for the merchant.

At a search step 13, the loyalty identifiers management server therefore makes a search, in its database for example, to see if the specific loyalty identifier for the given user and merchant is associated with the general loyalty identifier transmitted by the transaction device. To this end, the loyalty identifiers management server needs not only the general loyalty identifier but also a piece of data enabling it to identify the merchant.

According to a first variant, this piece of merchant's identification data is obtained via the request sent out by the transaction device, which comprises for example an identifier of the merchant (ID_A), as illustrated in FIGS. 1 and 2. The request can also include an identifier of the transaction device, or a public key of the transaction device, used to identify the merchant associated with the transaction device in a unique manner.

According to a second variant, the loyalty identifiers management server can obtain the piece of data on identification of the merchant by other means than the request itself, such as for example via a piece of information on location of the transaction device, obtained outside the context of the request, which then makes it possible, via means internal to the server, to uniquely identify the merchant associated with the transaction device.

Besides, the loyalty identifiers management server is capable of recognizing a specific loyalty identifier from a piece of identification data of a merchant, for example through means for converting the identification data of a merchant into a loyalty identifier having a pre-determined format. Thus, the search step 13 can comprise a sub-step of conversion of the identification data of a merchant into a format capable of being compared with specific loyalty identifiers liable to be associated with the user's general loyalty identifier.

If a specific loyalty identifier for the given user and merchant is associated with the user's general loyalty identifier, the loyalty identifiers management server responds to the request of the transaction device by transmitting to it the specific loyalty identifier found (for example ID_A_U1), as illustrated in FIGS. 1 and 2.

On the other hand, if, during the search step 13, the loyalty identifiers management server has not found the specific loyalty identifier for the given user and merchant, the server sends back a negative response (for example “KO”) to the transaction device.

According to variants of embodiments, the server can of course indicate the reason for the failure in its negative response so that the transaction device can, if necessary, implement appropriate action.

For example, the failure can be due to the fact that this specific loyalty identifier has not been preliminarily associated with the user's general loyalty identifier (the case illustrated in FIG. 3 described here below) or due to the fact that the user's general loyalty identifier does not exist, or again due to the fact that the loyalty identifiers management server has not succeeded in identifying the merchant.

The loyalty identifiers management server therefore makes it possible, via the different embodiments of the proposed method for managing loyalty identifiers, to carry out a centralized management of a user's different identification data, called specific loyalty identifiers, in the different loyalty programs of which he is a member, and this is done through a general loyalty identifier. The management of loyalty is therefore appreciably simplified for the user who no longer has to search for specific data on a loyalty program when he wishes to enjoy the advantages related to this loyalty program but only has to give his general loyalty identifier.

### 5.3. Method for Processing Loyalty Data

According to a second aspect, the proposed technique therefore relates to a method for processing loyalty data, implemented in a merchant's transaction device, for example at the time of a purchase, according to one particular embodiment.

According to this embodiment, this method enables a user to enjoy the benefits related to his membership in a specific loyalty program, for a given merchant, without having to furnish data specific to this program but in using a general loyalty identifier (previously generated and updated according to the method for managing loyalty identifiers described here above).

Classically, the processing of loyalty data within a transaction device (for example an electronic payment terminal or a cash register), enables the merchant to reliably and efficiently manage the data involving the user's payment means: the processing of this data must be carried out in a secured manner so that they (the data) cannot be stolen or usurped. Thus, a merchant's transaction device has characteristics that are used to carry out reliable and secured processing of this data. In fact, this processing of loyalty data is carried out mostly after the confirmation of the transaction, using data remaining in the possession of the terminal (therefore using the data that the terminal has taken care to preserve in the secured memory). In addition, the transaction device generally communicates with a specific loyalty program management server associated with the merchant.

As already described here above, the principle of the use of a general loyalty identifier (which enables the user to greatly simplify the management of his different loyalty programs) relies on the transmission, by a merchant's transaction device to a loyalty identifiers management server, of this general loyalty identifier to obtain in return the user's specific loyalty identifier for the given merchant. Once this specific loyalty identifier has been obtained, the transaction device can implement a “classic” processing of this loyalty data for example by communicating with a local server.

The first step, illustrated for example in FIG. 2, therefore consists, for the transaction device of a merchant A, in obtaining this general loyalty identifier ID_GEN_U1 for the user U/making a purchase.

This obtaining step can be implemented for example according to the following different means:
the user provides his general loyalty identifier to the merchant: this user has for example displayed his general loyalty identifier on his smartphone, via the preliminarily installed dedicated loyalty application, and the merchant enters it by hand or scans it in his transaction device. The manual scan can also be done by the user himself. The general loyalty identifier can also take the form of a QR code, displayed for example on the user's smartphone and read by the transaction device;
the user presents his smartphone in proximity to the transaction device and his general loyalty identifier is transmitted automatically, for example via the dedicated application preliminarily installed on his smartphone communicating with the transaction device through contactless communication means (of the NFC type) or very short range communications means (Bluetooth);
the transaction device automatically obtains the general loyalty identifier via a technique for mimicking the magnetic field generated by a magnetic stripe card, enabling the transmission, to a transaction device, at the same time as the information on the user's payment card, of data known as secondary data intended for example to confirm, augment or complete the payment operation carried out (such as for example secondary data on the membership of the user in a loyalty program of this brand, and more particularly his general loyalty identifier).

Thus, according to the embodiment, the management of loyalty can be made entirely automatic for the user, making it optimal and efficient, in terms of both ergonomy and security, and the exchanges between the user's communications terminal and the transaction device can be secured (by techniques known per se and not described in detail herein).

Once this general loyalty identifier has been obtained, the transaction device therefore, in a second step, sends out a request to the loyalty identifiers management server with the aim of obtaining the specific identifier that will enable it to manage the user's loyalty for the merchant concerned. For example, as illustrated in FIG. 2, and as already described here above, the request Req_A (ID_Gen_U1, ID_A) also comprises an identifier of the merchant (in the form of an identifier of the transaction device itself, of a public key of this transaction device, or again a standardized identifier of the merchant, etc.).

In return, the transaction device receives the specific loyalty identifier required and processes it in a third processing step 22 that can include the following sub-steps:
a step of transmission of the user's specific loyalty identifier for the merchant to a specific loyalty program server associated with the merchant, for example a local server intended to manage the merchant's loyalty programs for all his customers/users;
a step of management of the specific server's response that could take for example the following classic forms: printing on the cash receipt that loyalty has been considered; display on the transaction device of the considering of loyalty, printing of a reduction coupon, sending by SMS (or email or other) of the reduction coupon or promotion offers, etc.

Thus, on the basis of a general loyalty identifier given by a user, the transaction device can implement a method for managing loyalty data enabling the user to be able to obtain the benefits offered by his membership in the merchant's loyalty program.

It can happen however that the request transmitted by the transaction device to the loyalty identifiers management server fails, for different reasons described here above.

The second embodiment, illustrated in FIG. 3, corresponds for example to one of these situations in which a specific loyalty identifier for a merchant D has not been previously associated with the user's general loyalty identifier. Thus, when the transaction device of merchant D, at the time of a purchase made by the user U1, sends out a request Req D (ID_Gen_U1, ID_D) in order to obtain a specific loyalty identifier, it receives a negative response from the loyalty identifiers management server, indicating the reason for the failure.

The proposed method remedies this situation by proposing an update of the user's general loyalty identifier at the initiative of the transaction device (and no longer, as in the most frequent case described here above with reference to FIG. 2, at the initiative of user's communications terminal via an application for example).

To this end, at a step 21 the transaction device obtains a specific loyalty identifier for the user. For example, this obtaining is done via the specific loyalty program management server associated with the merchant, which is capable of creating a specific identifier for a new member (i.e. the user).

This specific loyalty identifier obtained is then transmitted to the loyalty identifiers management server by the transaction device with the user's general loyalty identifier. For example, this transmission is done by sending an update request MaJ (ID_Gen_U1, ID_D_U1), as described here above in relation to the first embodiment.

An update step 12 is then implemented in the loyalty identifiers management server as already described in relation to the first embodiment except that the update is not initiated by a user's communications terminal but by a merchant's transaction device. By contrast, for the loyalty identifiers management server, the implementation is identical for this update, i.e. it associates a specific loyalty identifier additional to the general loyalty identifier (which is kept associated with four specific loyalty identifiers, respectively for the merchant's A, B, C and D).

Finally, for this update step, the loyalty identifiers management server communicates with the user's communications terminal, for example via the dedicated application APPLI in order to provide it with confirmation of the update of the user's general loyalty identifier. In this way, even if the application is not at the initiative of this update, it has knowledge of it in order to be able itself to offer the user an updated vision of his loyalty.

It must be noted that this updating of the user's general loyalty identifier at the initiative of a merchant's transaction device requires the user's prior authorization inasmuch as this general loyalty identifier is a piece of personal data which he should be able to fully use and update.

According to a first variant, the user's authorization is required at the time of the update or just before, when the transaction device has received a negative response from the loyalty identifiers management server. For example, a confirmation of the update can be requested from the user via an entry on the keypad of the transaction device (for example by pressing the OK key in response to a question) or again orally via the merchant who will then confirm the user's assent on his transaction device. According to another example, the transaction device communicates with the user's communications terminal (by one of the means already described here above), for example via the dedicated loyalty application, and it is this application that requires authorization by the user (through a specific screen displayed on the communications terminal for example). Once the authorization is confirmed by the user on his communications terminal, it is transmitted to the transaction device so that it transmits his update request to the loyalty identifiers management server. These means of communication between the transaction device and the user's communications terminal are for example those described with reference to the obtaining, by the transaction device, of the user's general loyalty identifier, or any other communications means enabling secured transmission.

According to a second variant, the user has given a prior general authorization for the updating of his general loyalty identifier, for example in configuring his loyalty profile, through the dedicated application installed in his communications terminal. The user can thus confirm that any update of his general loyalty identifier can be done, whether it is on the initiative of his loyalty application or that of a merchant's transaction device provided that this merchant is authorized, for example through a public key or a unique identifier (according to protocols known per se). According to this second variant, this general update authorization can for example be an attribute of the general loyalty identifier, this attribute being created at the same time as the identifier or else added subsequently when the user wishes it. This attribute can be included or recognized or decoded by the transaction device from the general loyalty identifier itself. In this way, the transaction device knows that it does not have to ask for the user for authorization and can therefore transmit his update request directly to the loyalty identifiers management server.

In parallel, the transaction device can implement the step 22 (already described here above and not described again here) for processing the specific loyalty identifier obtained in order to make the user enjoy the benefits related to his membership in the merchant's loyalty program.

Thus, according to this second embodiment, on the basis of a general loyalty identifier given by a user, the transaction device can implement a method for managing loyalty data enabling the user to be able to enjoy the benefits offered by his membership in the merchant's loyalty program, even if he takes membership at the time of the transaction. A user's membership in a loyalty program can therefore be taken into account simply and instantaneously, at the time of a purchase.

### 5.4. Loyalty Application

As already described here above with reference to the two embodiments of the proposed technique, the user can install an application dedicated to the management of his loyalty programs on his communications terminal.

Such a communications terminal can for example be a smartphone or tablet type communications terminal, an autonomous dedicated electronic device or again an electronic device intended to be coupled to a communications terminal (the electronic device can then for example be integrated into a protective casing of the communications terminal).

Such an application can especially be an electronic wallet type of application which makes it possible especially to store information associated with several cards as well as complementary information.

Through this application, the user especially has the possibility of choosing the payment information to be used for a payment operation on a case-by-case basis. He also has the possibility of configuring payment information known as “default” information which will be the data used by default in the context of a payment operation (barring another particular choice made by the user).

Through this application, the user can therefore also, according to the proposed technique already described here above, create a general loyalty identifier on the basis of which a loyalty identifiers management server is capable of retrieving a specific loyalty identifier of the user to be used in the context of a given payment operation.

The user can also update this general loyalty identifier via this dedicated application when he so wishes, for example in order to add a new specific loyalty program, such as for example a new physical loyalty card, the bar code of which he must scan in order to integrate it into the centralized management of his loyalty via the application, or again in order to add a specific loyalty identifier obtained upon taking membership in a merchant's loyalty program.

This application also enables the user to create and update a loyalty profile, for example to confirm a general authorization of update as described here above with reference to the second embodiment.

### 5.5. Other Features and Advantages

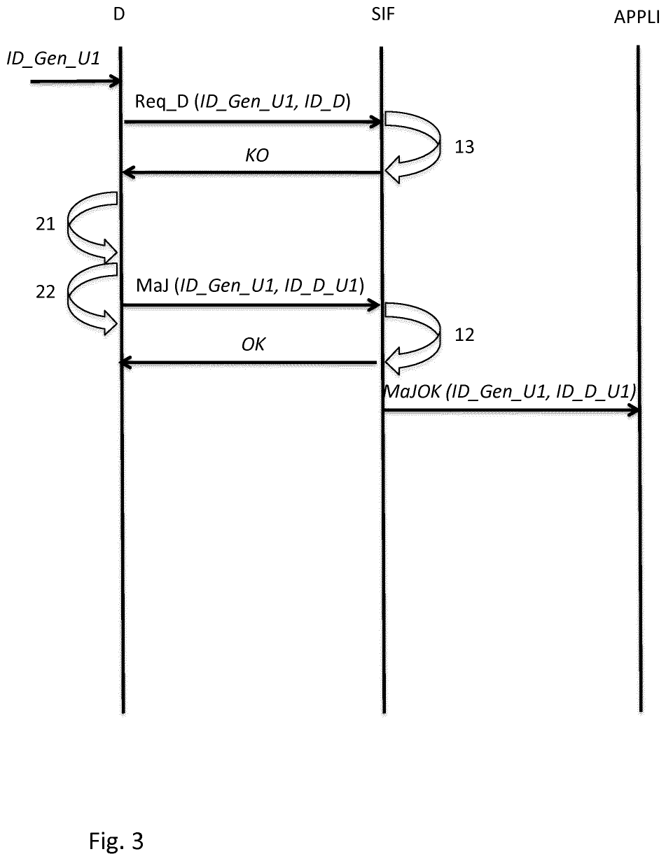

Referring to FIG. 4, we describe a loyalty identifiers management server comprising means for executing a method for managing loyalty identifiers, described here above with reference to the particular embodiments.

For instance, the loyalty identifiers management server comprises a memory 41 constituted by a buffer memory, a processing unit 42, equipped for example with a microprocessor, and driven by the computer program 43, implementing especially a method for managing loyalty identifiers. At initialization, the code instructions of the computer program 43 are for example loaded into a memory and then executed by the processor of the processing unit 42. The processing unit 42 receives for example at the input E at least one request for generating a general loyalty identifier for a pre-identified user. The microprocessor of the processing unit 42 then implements the steps of the method for managing loyalty identifiers according to the instructions of the computer program 43 so as to generate at output a general loyalty identifier for the user in question.

To this end, the loyalty identifiers management server comprises, in addition to the buffer memory 41, means for example in the form of one or more modules for generating a general loyalty identifier for a previously identified user.

All these means/modules can take the form of a particular processor implemented within the loyalty identifiers management server, said processor being a secure processor, capable of processing confidential data such as payment means data or bank authentication tokens.

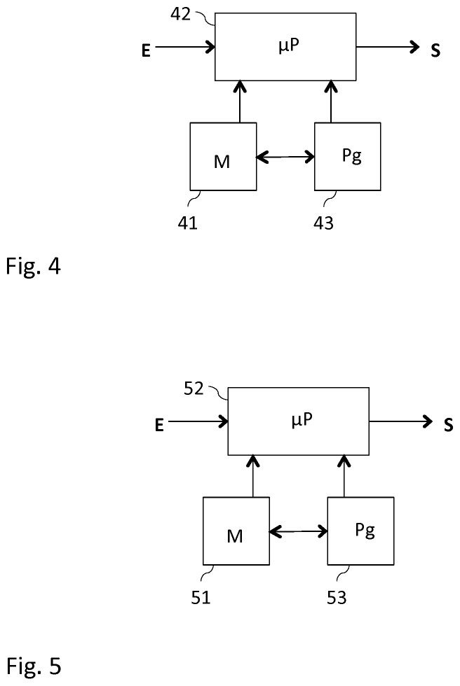

The proposed technique also relates to a transaction device implementing the execution of a method for processing loyalty data described here above, according to the particular embodiments. Such a transaction device especially described with reference to FIG. 5 in one particular embodiment, and it comprises the following means, for example the form of modules:
means for obtaining, from a user, of a general loyalty identifier of the user;
means for sending, to a loyalty identifiers management server, a request for obtaining a specific loyalty identifier of the user for the merchant, the request for obtaining comprising at least the user's general loyalty identifier;
means of reception, coming from the loyalty identifiers management server, of a response to the request for obtaining and, if said response comprises the specific loyalty identifier of the user for the merchant:
means for processing at least one piece of loyalty data associated with the user's specific loyalty identifier.

For example, the transaction device comprises a memory 51 constituted by a buffer memory, a processing unit 52, equipped for example with a microprocessor and driven by the computer program 53, implementing especially a method for processing loyalty data. At initialization, the code instructions of the computer program 53 are for example loaded into a memory and then executed by the processor of the processing unit 52. The processing unit 52 receives for example at input E a general loyalty identifier of the user. The microprocessor of the processing unit 52 then implements the steps of the method for processing loyalty data according to the instructions of the computer program 53, so as to generate, at output S, loyalty advantages for the user in question.

To this end, the transaction device comprises, in addition to the buffer memory 51, means of transmission/reception of data which can take the form of an interface connection with one or more communications networks, these means make it possible, if necessary, to set up a link with partner servers for the management of loyalty programs. The payment terminal also comprises, if necessary, means of cryptographic computation enabling it to verify the authenticity of the data received with an authentication token.

The embodiments described here above in the context of the present invention can be combined with one another. They are therefore given by way of illustratory and non-exhaustive examples in order to best illustrate the general principle of the invention. Other embodiments can of course be implemented in the context of the present invention.

1. A method of management of loyalty identifiers, the method being implemented in a loyalty identifiers management server and comprising the following acts:
a phase of initialization comprising for generating a general loyalty identifier for a preliminarily identified user, said general loyalty identifier being associated with a plurality of specific loyalty programs of said user;
obtaining an authorization from said user for updating said general loyalty identifier;
receiving, from a merchant's transaction device, a request for updating said general loyalty identifier of said user, said update request comprising said general loyalty identifier of said user and at least one specific loyalty identifier of said user for said merchant; and
updating said general loyalty identifier by association between said at least one specific loyalty identifier of said user for said merchant and said general loyalty identifier of said user.

2. The method of management of loyalty identifiers according to claim 1, wherein said phase of initialization also comprises the following acts respectively before and after said act of generating:
receiving a request, from the user's communications terminal, for generating a general loyalty identifier associated with said user, said request for generation comprising at least one piece of data for identifying said user;
transmitting, to said communications terminal of said user, a response comprising said general loyalty identifier generated.

3. (canceled)

4. The method of management of loyalty identifiers according to claim 1, further comprising an act of transmission, to the said communications terminal of said user, of a piece of information representing said updated general loyalty identifier.

5. The method of management of loyalty identifiers according to claim 1, further comprising the following acts:
receiving, from a transaction device associated with a merchant, of a request for obtaining a specific loyalty identifier of said user for said merchant, said request for obtaining comprising said general loyalty identifier of said user;
obtaining at least one piece of identification data for said merchant;
searching, on the basis of said identification data of said merchant and said general loyalty identifier of said user, for said specific loyalty identifier of said user for said merchant:
when said search is positive, transmission to said transaction device of a response comprising said specific loyalty identifier of said user for said merchant;
when said search is negative, transmission to said transaction device of a negative response.

6. A method for processing loyalty data, the method being implemented in a transaction device of a merchant and comprises the following acts:
obtaining, from a user, a general loyalty identifier of said user, said general loyalty identifier being associated with a plurality of specific loyalty programs of said user;
sending, to a loyalty identifiers management server, a request for obtaining a specific loyalty identifier of said user for said merchant, said request for obtaining comprising at least said general loyalty identifier of said user;
receiving, from said loyalty identifiers management server, a response to said request for obtaining and, in response to said response comprising said specific loyalty identifier of said user for said merchant:
processing at least one piece of loyalty data associated with a specific loyalty identifier of said user for said merchant.

7. The method for processing loyalty data according to claim 6, further comprising the following acts in response to said response is-being negative:
obtaining a specific loyalty identifier of said user for said merchant;
sending, to said loyalty identifiers management server, a request for updating said loyalty identifier of said user, said request for updating comprising said user's general loyalty identifier and said specific loyalty identifier of said user for said merchant;
processing at least one piece of loyalty data associated with said specific loyalty identifier of said user for said merchant.

8. The method for processing loyalty data according to claim 6, wherein said act of obtaining a specific loyalty identifier for said merchant and said act of processing are implemented via a specific loyalty programs management server associated with said merchant.

9. The method for processing loyalty data according to claim 6, wherein said act of obtaining a general loyalty identifier of said user is implemented via communications means with a communications terminal of said user belonging to the sub-group consisting of:
NFC;
Bluetooth;
MST (Magnetic Secure Transmission).

10. (canceled)

11. A transaction device comprising:
a processor; and
a non-transitory computer-readable medium comprising instructions stored thereon which when executed by the processor configure the transaction device to perform acts comprising:
obtaining, from a user, a general loyalty identifier of said user, said general loyalty identifier being associated with a plurality of specific loyalty programs of said user;
sending, to said loyalty identifiers management server, a request for obtaining a specific loyalty identifier of said user for said merchant, said request for obtaining comprising at least said general loyalty identifier of said user;
receiving, from said loyalty identifiers management server, a response to said request for obtaining and, if said response comprises said user's specific loyalty identifier for said merchant:
processing at least one piece of loyalty data associated with said specific loyalty identifier of said user for said merchant.

12. (canceled)

13. (canceled)
